(19) United States
(12) Patent Application Publication
(10) Pub. No.: US 2024/0303629 A1
(43) Pub. Date: Sep. 12, 2024

(54) SYSTEMS AND METHODS TO SECURE OPEN LOOP AUTHENTICATION ON PRIVATE LABEL CREDIT CARDS

(71) Applicant: Capital One Services, LLC, McLean, VA (US)

(72) Inventor: Srinivasa CHIGURUPATI, Long Grove, IL (US)

(21) Appl. No.: 18/118,945

(22) Filed: Mar. 8, 2023

(51) Int. Cl. G06Q 20/34

(52) U.S. Cl. CPC G06Q 20/34

(57) ABSTRACT

Systems and methods for provisioning and processing open-loop private label credit cards in store and forward transaction processing machines may include establishing communication between the transaction processing device operating in an offline store and forward transaction mode and a card data processor of a transaction card presented to a merchant for use in completing a point-of-sale (POS) transaction. The transaction processing device may receive card information from the card data processor including a card identifier and a card registered unique identifier (RID). The transaction processing machine may determine whether the card RID matches a merchant RID stored in a memory of the transaction processing device. Responsive to a determination that the card RID matches the merchant RID, the processing device may allow the POS transaction to continue processing through the transaction processing device as an open-loop, offline store and forward POS transaction.

### FIELD OF THE DISCLOSURE

The present disclosure relates to systems and methods for preventing incorrect authorization of private label credit cards in open loop authentication implementation systems.

### BACKGROUND

Credit card payment processing is historically handled on an open-loop or closed-loop basis. Credit cards issued by banks and serviced through a card network, such as Visa® or Mastercard® are considered open-loop. These cards are generally accepted at a wide range of merchants. Closed-loop cards, on the other hand, are generally private label credit cards (PLCC) issued by a specific merchant through a direct relationship with the merchant's acquiring bank. PLCCs are popular for merchants because they are intended only for use at the specific merchant. This promotes customer loyalty and allows the merchant to provide rewards, etc. Additionally, there are reduced transaction costs because closed-loop transactions do not use a card network. Instead, closed-loop transactions are based on a direct connection with the merchant acquiring bank (MAB) for direct approval or rejection of an attempted transaction.

Some merchants offer PLCCs that operate through a card network such as such as Visa® or Mastercard®. These cards are intended for use only at the issuing merchant, but they utilize an existing relationship with a third-party processor on a card network, as opposed to maintaining a direct connection with a MAB. While the specific authorization process for this type of PLCC (open-loop) is different from that of a closed-loop PLCC, the end result is generally the same, namely approval or rejection of a proposed transaction at the issuing merchant.

There exists, however, a potential difference between open-loop and closed-loop PLCCs when the cards are offered for payment at a third-party merchant. Under normal circumstances, in the case of a closed-loop PLCC, an attempted transaction at a third-party merchant will be denied because the third-party merchant's point of sale (POS) device will not be able to connect to the MAB. In the case of an open-loop PLCC, the transaction request should travel through the card network and ultimately be rejected when the MAB sees the transaction request originated from a POS device of a third-party merchant.

Sometimes, though, POS devices are running in “store and forward” mode which is offline transaction approval. In these instances, a closed-loop PLCC will be refused as in the normal case, but an open-loop PLCC may be approved because the card number matches an otherwise valid number for a card network. When the stored open-loop PLCC transactions is ultimately forwarded through the card network for approval, it will be denied.

These and other deficiencies exist. Accordingly, there is a need for determining and rejecting attempted transactions by open-loop PLCC cards at third-party merchant POS terminals operating in store and forward mode.

### SUMMARY OF THE DISCLOSURE

In some aspects, the techniques described herein relate to a method of provisioning a merchant transaction card having a card data processor and a card memory, the method including: obtaining, by a card account management system associated with a financial institution, a registered identifier (RID) uniquely associated with the financial institution and a merchant; associating, by the card account management system, chip card information with a card account associated with an account holder, the chip card information including a unique chip card identifier; constructing at least one card manager encryption key using the RID and card-unique chip card information; transmitting, by the card account management system to a provisioning data processing system, the chip card information, the RID, the at least one card manager encryption key, and account holder information associated with the account holder; loading, by the provisioning data processing system into the card memory, the chip card information, the RID, and the at least one card manager encryption key; and loading, by the provisioning data processing system into the card memory, a transaction processor applet and at least one transaction processor encryption key associated with a transaction processing entity.

In some aspects, the techniques described herein relate to a method further including: encrypting at least a portion of the chip card information by the card account management system prior to the action of transmitting.

In some aspects, the techniques described herein relate to a method wherein the at least a portion of the chip card information is encrypted using the at least one card manager encryption key.

In some aspects, the techniques described herein relate to a method further including: encrypting the RID by the card account management system prior to the action of transmitting.

In some aspects, the techniques described herein relate to a method wherein the at RID is encrypted using the at least one card manager encryption key.

In some aspects, the techniques described herein relate to a method further including: storing, by the card account management system in a card account database, a card account record including a card account identifier, the account holder information, and at least a portion of the chip card information.

In some aspects, the techniques described herein relate to a method wherein the merchant transaction card is configured for communication with a merchant transaction card processing device and the chip card information and the RID are configured for use by the merchant transaction card processing device to direct transaction processing information to a transaction processing system of the financial institution.

In some aspects, the techniques described herein relate to a method for processing a merchant account card transaction, the method including: establishing communication, by a transaction processing device operating in an offline store and forward transaction mode, with a card data processor of a transaction card presented to a merchant for use in completing a point-of-sale (POS) transaction; receiving card information by the transaction processing device from the card data processor, the card information including a card identifier and a card registered unique identifier (RID); determining, by the transaction processing device, whether the card RID matches a merchant RID stored in a memory of the transaction processing device and associated with the merchant and a financial institution; responsive to a determination that the card RID does not match the merchant RID, refusing the POS transaction by the transaction processing device; and responsive to a determination that the card RID matches the merchant RID, allowing the POS transaction to continue processing through the transaction processing device as an open-loop, offline store and forward POS transaction.

In some aspects, the techniques described herein relate to a method wherein the method further includes, responsive to a determination that the card RID matches the merchant RID: determining, by the transaction processing device, whether the card information includes an encrypted security block; and responsive to determining that the card information includes an encrypted security block, attempting to decrypt the encrypted security block using a merchant-unique security key, wherein the action of allowing the POS transaction to continue processing through the transaction processing device as an open-loop, offline store and forward POS transaction is carried out only upon successful decryption of the encrypted security block.

In some aspects, the techniques described herein relate to a method further including, responsive to a determination that the card information does not include an encrypted security block: denying the POS transaction by the transaction processing device.

In some aspects, the techniques described herein relate to a method further including, responsive to a failure to decrypt the encrypted security block: denying the POS transaction by the transaction processing device.

In some aspects, the techniques described herein relate to a method wherein the merchant-unique security key is generated using the merchant RID.

In some aspects, the techniques described herein relate to a method wherein the encrypted security block includes encrypted account holder information.

In some aspects, the techniques described herein relate to a method further including, responsive to a determination that the card RID matches the merchant RID: prior to forwarding a stored transaction through an open-loop card network, encrypting at least a portion of the transaction information using the merchant-unique security key, the encrypted portion of the transaction information being included in the transaction processing request.

In some aspects, the techniques described herein relate to a point-of-sale (POS) transaction processing device operating in an offline store and forward transaction mode including: a transaction card communication interface configured to establish communication with a card data processor of a transaction card presented for use in completing a POS transaction at a POS location associated with a merchant; a network communication interface configured for selective communication over a network; a data processor; a transaction processor memory having stored therein a transaction processing application including instructions for the data processor to: receive card information from the card data processor via the transaction card communication interface, the card information including a card identifier and a card registered unique identifier (RID), determine whether the card RID matches a merchant RID associated with the merchant and a financial institution, responsive to a determination that the card RID matches the merchant RID, allowing the POS transaction to continue processing through the transaction processing device as an open-loop, offline store and forward POS transaction.

In some aspects, the techniques described herein relate to a POS transaction processing device wherein the transaction processing application further includes instructions for the data processor to: responsive to a determination that the card RID does not match the merchant RID, refuse the POS transaction by the transaction processing device.

In some aspects, the techniques described herein relate to a POS transaction processing device wherein the transaction processor memory also has stored therein a merchant-unique security key associated with the merchant and the financial institution and the transaction processing application further includes instructions for the data processor to, responsive to a determination that the card RID matches the merchant RID, determine whether the card information includes an encrypted security block, and responsive to determining that the card information includes an encrypted security block, attempt to decrypt the encrypted security block using the merchant-unique security key, and carry out the action allow the POS transaction to continue processing through the transaction processing device as an open-loop, offline store and forward POS transaction only upon successful decryption of the encrypted security block.

In some aspects, the techniques described herein relate to a POS transaction processing device wherein the transaction processing application further includes instructions for the data processor to, responsive to either a determination that the card information does not include an encrypted security block or a failure to decrypt the encrypted security block, deny the POS transaction by the transaction processing device.

In some aspects, the techniques described herein relate to a POS transaction processing device wherein the encrypted security block includes encrypted account holder information.

In some aspects, the techniques described herein relate to a POS transaction processing device wherein the transaction processing application further includes instructions for the data processor to, responsive to a determination that the card RID matches the merchant RID: prior to the action of forwarding a stored transaction through an open-loop card network, encrypt at least a portion of the transaction information using the merchant-unique security key.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 illustrates a system for provisioning an open-loop PLCC with store and forward security.

FIG. 2 illustrates a system for processing an open-loop PLCC at a third-party merchant with a transaction processing machine operating in store and forward mode.

FIG. 3 is a flow diagram illustrating closed-loop authentication.

FIG. 4 is a flow diagram illustrating open-loop authentication.

FIG. 5 illustrates a sequence of operations for provisioning an open-loop PLCC with store and forward security.

FIG. 6 illustrates a sequence of operations for provisioning an open-loop PLCC with store and forward security.

FIG. 7 is a schematic representation of a transaction processing machine usable in implementing embodiments of the invention.

FIG. 8 illustrates a sequence of operations for processing an open-loop PLCC at a third-party merchant with a transaction processing machine operating in store and forward mode.

FIG. 9 illustrates a sequence of operations for processing an open-loop PLCC at a third-party merchant with a transaction processing machine operating in store and forward mode.

### DETAILED DESCRIPTION

The following description of embodiments provides non-limiting representative examples referencing numerals to particularly describe features and teachings of different aspects of the invention. The embodiments described will be recognized as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments will learn and understand the different described aspects of the invention. The description of embodiments will facilitate understanding of the invention to such an extent that other implementations, not specifically covered but within the knowledge of a person of skill in the art having read the description of embodiments, will be understood to be consistent with an application of the invention.

A person of ordinary skill in the art will recognize that the embodiments may be practiced without one or more of the specific features or advantages of an embodiment. In other instances, additional features and advantages may be recognized in certain embodiments that may not be present in all embodiments. A person of ordinary skill in the art will understand that the described features, advantages, and characteristics of any embodiment can be interchangeably combined with the features, advantages, and characteristics of any other embodiment.

The present invention provides systems and methods for securing PLCC cards running open-loop authentication, from use at third-party merchants. PLCCs are issued by specific merchants, generally for use only at that specific merchant. These types of PLCCs operate using closed-loop authentication, but that is not always the case. In the event that a PLCC relies on an open-loop authentication architecture, there is a possibility for unintended authorization of the PLCC at a merchant other than the one that issued the PLCC. When an open-loop PLCC is offered for payment at a third-party merchant and that third party merchant's POS device is operating in store and forward mode, the unintended authorization may occur. In store and forward mode, the POS device recognizes general information about a card presented for payment, such as expiration data and whether the card number is valid for an open-loop card network. The POS device may approve the transaction based on these indicia of a valid card and then later send the transaction request through the card network for authorization. It is at this point that an open-loop PLCC for a different merchant will be refused.

The present invention provides systems and methods for preventing mistaken approval of these types of PLCCs at non-issuing merchants. Benefits of these systems and methods are reduction in losses due to fraud and accidental PLCC misuse and also provides a better customer experience by providing appropriate response messages from Chip to the POS terminal during the card authentication process.

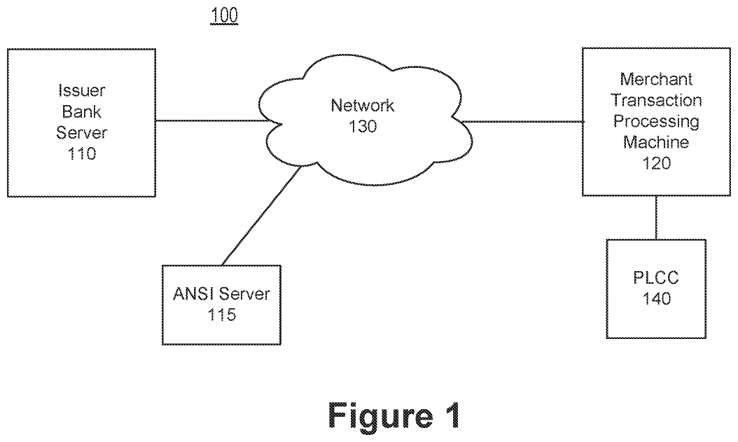

With reference to FIG. 1, a store and forward security open-loop PLCC provisioning system 100 according to an example embodiment may include an issuer bank server 110 in communication with an American National Standards Institute (“ANSI”) server 115 and a merchant transaction processing machine 120 via a network 130. The ANSI server 115 may be responsible for issuing and tracking unique identification numbers. The merchant transaction processing machine 120 may be in communication with PLCC 140 via physical or touchless interface. Without limitation, merchant transaction processing machine 120 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an ATM, or other device.

The merchant transaction processing machine 120 may include processing circuitry and may contain additional components, including processors (e.g., microprocessors), memories, error and parity/CRC checkers, data encoders, anticollision algorithms, controllers, command decoders, security primitives and tamper-proofing hardware, as necessary to perform the functions described herein. The merchant transaction processing machine 120 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the merchant transaction processing machine that is available and supported by the merchant transaction processing machine, such as a touchscreen, keyboard, keypad, mouse, cursor-control device, touchscreen, microphone, digital camera, video recorder or camcorder. These devices may be used to enter information and interact with the software and other devices described herein.

The network 130 may be or include a wireless network, a wired network or any combination of wireless network and wired network. The network 130 may, for example, include one or more of a fiber optics network, a passive optical network, a cable network, an Internet network, a satellite network, a wireless LAN, a Global System for Mobile Communication (GSM), a Personal Communication Service (PCS), a Personal Area Network, Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g, Bluetooth, Near Field Communication (NFC), Radio Frequency Identification (RFID), Wi-Fi, and/or the like.

In addition, the network 130 may include, without limitation, telephone lines, fiber optics, IEEE Ethernet 902.3, a wide area network (WAN), a wireless personal area network, a local area network (LAN), or a global network such as the Internet. In addition, the network 130 may support an Internet network, a wireless communication network, a cellular network, or the like, or any combination thereof. The network 130 may further include one network, or any number of the exemplary types of networks mentioned above, operating as a stand-alone network or in cooperation with each other. The network 130 may utilize one or more protocols of one or more network elements to which they are communicatively coupled. The network 130 may translate to or from other protocols to one or more protocols of network devices. Although the network 130 is depicted as a single network, it should be appreciated that according to one or more examples, the network 130 may comprise a plurality of interconnected networks, such as, for example, the Internet, a service provider's network, a cable television network, corporate networks, such as credit card association networks, and home networks.

In some examples, the issuer bank server 110 can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a single server, it is understood that other embodiments can use multiple servers or multiple computer systems as necessary or desired to support the users and can also use back-up or redundant servers to prevent network downtime in the event of a failure of a particular server.

The issuer bank server 110 may include an application in memory comprising instructions for execution thereon. For example, the application may comprise instructions for execution on the server. The application may be in communication with any components of system 100. For example, the server may execute one or more applications that enable, for example, network and/or data communications with one or more components of system 100 and transmit and/or receive data. Without limitation, the server may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. The server also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server may include processing circuitry and may contain additional components, including processors (e.g., microprocessors), memories, error and parity/CRC checkers, data encoders, anticollision algorithms, controllers, command decoders, security primitives and tamper-proofing hardware, as necessary to perform the functions described herein. The server may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

The network-enabled computer systems used to carry out the methods contemplated by the invention may execute one or more software applications to, for example, receive data as input from an entity accessing the network-enabled computer system, process received data, transmit data over a network, and receive data over a network. The one or more network-enabled computer systems may also include one or more software applications to send notifications to an account holder or other user. It will be understood that the depiction in FIG. 1 is an example only, and the functions and processes described herein may be performed by any number of network-enabled computers. It will also be understood that where the illustrated system 100 may have only a single instance of certain components, multiple instances of these components may be used. The system 100 may also include other devices not depicted in FIG. 1.

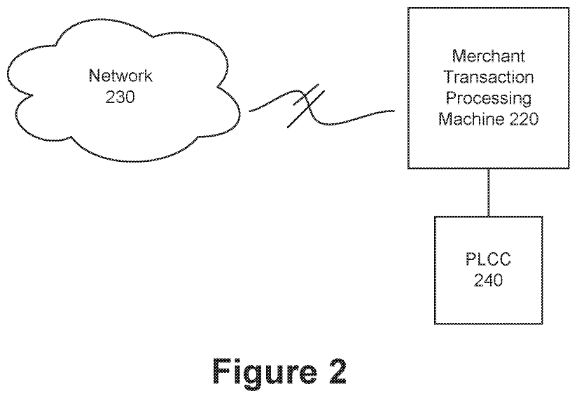

With reference to FIG. 2, a system for processing an open-loop PLCC at a third-party merchant with a transaction processing machine operating in store and forward mode may include a merchant transaction processing machine 220 in communication with a PLCC 240. The merchant transaction processing machine 220 may be in communication with PLCC 240 via physical or touchless interface. Physical interface may include swiping PLCC through a strip reader of merchant transaction processing machine 220 and/or physical insertion of the PLCC into merchant transaction processing machine 220. Touchless interface may include, without limitation, near-field communication (NFC), RFID, smart phone proxy, or any other means of touchless communication. In the system of FIG. 2, there may be a network 230, however merchant transaction processing machine 220 may not be connected to network 220 at the time when merchant transaction processing machine 220 is operating in store and forward mode and a PLCC transaction is attempted. Without limitation, merchant transaction processing machine 220 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an ATM, or other device.

The merchant transaction processing machine 220 may include processing circuitry and may contain additional components, including processors, memories, error and parity/CRC checkers, data encoders, anticollision algorithms, controllers, command decoders, security primitives and tamper-proofing hardware, as necessary to perform the functions described herein. The merchant transaction processing machine 220 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the merchant transaction processing machine that is available and supported by the merchant transaction processing machine, such as a touchscreen, keyboard, keypad, mouse, cursor-control device, touchscreen, microphone, digital camera, video recorder or camcorder. These devices may be used to enter information and interact with the software and other devices described herein.

The network 230 may be or include a wireless network, a wired network or any combination of wireless network and wired network. The network 130 may, for example, include one or more of a fiber optics network, a passive optical network, a cable network, an Internet network, a satellite network, a wireless LAN, a Global System for Mobile Communication (GSM), a Personal Communication Service (PCS), a Personal Area Network, Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g, Bluetooth, Near Field Communication (NFC), Radio Frequency Identification (RFID), Wi-Fi, and/or the like.

In addition, the network 130 may include, without limitation, telephone lines, fiber optics, IEEE Ethernet 902.3, a wide area network (WAN), a wireless personal area network, a local area network (LAN), or a global network such as the Internet. In addition, the network 130 may support an Internet network, a wireless communication network, a cellular network, or the like, or any combination thereof. The network 130 may further include one network, or any number of the exemplary types of networks mentioned above, operating as a stand-alone network or in cooperation with each other. The network 130 may utilize one or more protocols of one or more network elements to which they are communicatively coupled. The network 130 may translate to or from other protocols to one or more protocols of network devices. Although the network 130 is depicted as a single network, it should be appreciated that according to one or more examples, the network 130 may comprise a plurality of interconnected networks, such as, for example, the Internet, a service provider's network, a cable television network, corporate networks, such as credit card association networks, and home networks.

The merchant transaction processing machine 220 may be placed into store and forward mode. This operation mode may be offline and not in communication with network 230. PLCC 240 may be presented to merchant transaction processing machine 220 as payment for goods or services. The PLCC may not be issued for the merchant associated with merchant transaction processing machine 220. The PLCC may be issued for use at a single merchant, and the merchant transaction processing machine 220 may be associated with a third-party merchant. Presentation of PLCC 240 may initiate a transaction request at merchant transaction processing machine 220. The transaction request may not be forwarded to a third-party processor or a card network, and therefore may not be routed to the issuing bank for approval. In the system of FIG. 2, merchant transaction processing machine 220 may verify a RID stored in a memory of the PLCC that is unique to the issuing merchant. If that PLCC is not recognized by merchant transaction processing machine 220, then the transaction request may be denied without the need to route the transaction request through network 230.

In some examples, exemplary procedures in accordance with the present disclosure described herein can be performed by a computer hardware arrangement. Such a computer hardware arrangement can be, for example entirely or a part of, or include, but not limited to, a computer and/or processor that can include, for example one or more microprocessors, and use instructions stored on a non-transitory computer-accessible medium (e.g., RAM, ROM, hard drive, or other storage device). For example, a computer-accessible medium can be part of the memory of the components described herein or other computing and/or processing arrangement.

In some examples, a computer-accessible medium (e.g., as described herein, a storage device such as a hard disk, floppy disk, memory stick, CD-ROM, RAM, ROM, etc., or a combination thereof) can be provided (e.g., in communication with the computer hardware arrangement). The computer-accessible medium can contain executable instructions thereon. In addition or alternatively, a storage arrangement can be provided separately from the computer-accessible medium, which can provide the instructions to the computer hardware arrangement. The instructions can configure the computer hardware arrangement to execute certain exemplary procedures, processes, and methods, as described herein above, for example.

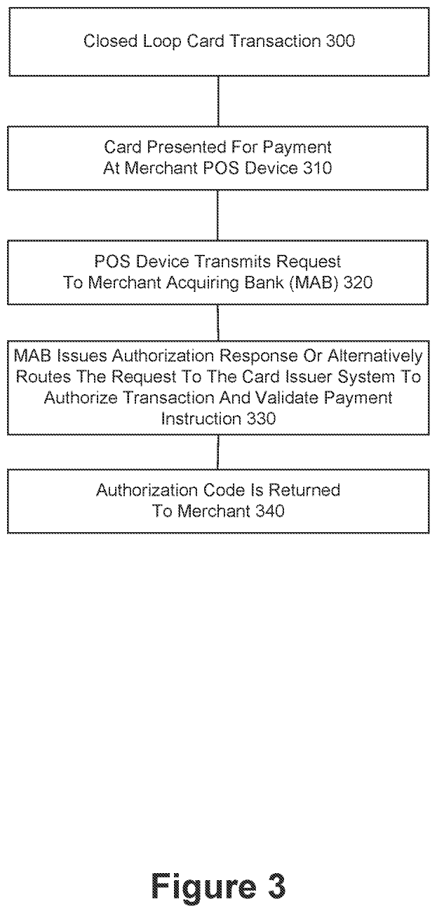

FIG. 3 illustrates an exemplary historical method for closed-loop credit card authentication. At step 300 the process begins. At step 310, a PLCC may be presented for payment at a point-of-sale device (e.g., a merchant transaction processing machine). A consumer may have previously acquired a PLCC from any merchant that offers such a card. PLCCs are generally accepted only at the merchant that issues the PLCC. In the case of a PLCC, the merchant acquiring bank is the same as the issuing bank, and therefore the transaction processing and approval is simplified. Merchants offering PLCCs benefit through reduced transaction costs because there is no need to transfer funds between an issuing bank and a merchant acquiring bank in order to settle the transaction, and therefore no funds transfer fees charged to the merchant. The merchant may also realize a benefit in providing a payment mechanism for consumers that is directly linked/limited to the merchant. In step 310, the user may present a PLCC for Merchant A to a POS device belonging to Merchant A. Alternatively, a user may present a PLCC for Merchant A to a POS device belonging to Merchant B. In either scenario, presenting the PLCC for payment at a POS device initiates a transaction request at the POS device.

In the scenario where PLCC for Merchant A is presented at Merchant A's POS device, at step 320, the POS device may connect with the merchant acquiring bank over a network connection. Once a connection has been established, the POS device may transmit the transaction request to the merchant acquiring bank. As noted, in the case of a PLCC, the merchant acquiring bank is the same as the issuing bank, so the merchant acquiring bank is equipped to make an authorization determination for the transaction request. At step 330, the merchant acquiring bank may make an authorization decision for the transaction request. This decision may be based off of any number of criteria. For instance, a decision to reject the transaction may be based on the PLCC being expired, in bad standing, over-limit, etc. A decision to reject may also be based on any number of fraud-based indicia. If the merchant acquiring bank approves the transaction request, then at step 340, an authorization code may be returned to the merchant POS device and the transaction may be finalized.

In the scenario where a PLCC for Merchant A is presented at Merchant B's POS device, then at step 320, the merchant POS device may attempt to connect with Merchant B's merchant acquiring bank. In one embodiment, this attempt may fail and the transaction refused. In another embodiment, the connection with Merchant B's merchant acquiring bank may be successful. In this case, the transaction request may be forwarded to the merchant acquiring bank at step 320. At step 330, the merchant acquiring bank will reject the transaction request because the account information associated with the PLCC will not match a valid account for Merchant B. In this scenario, a refusal response may be returned to the POS device at step 340, and the transaction will be refused by Merchant B.

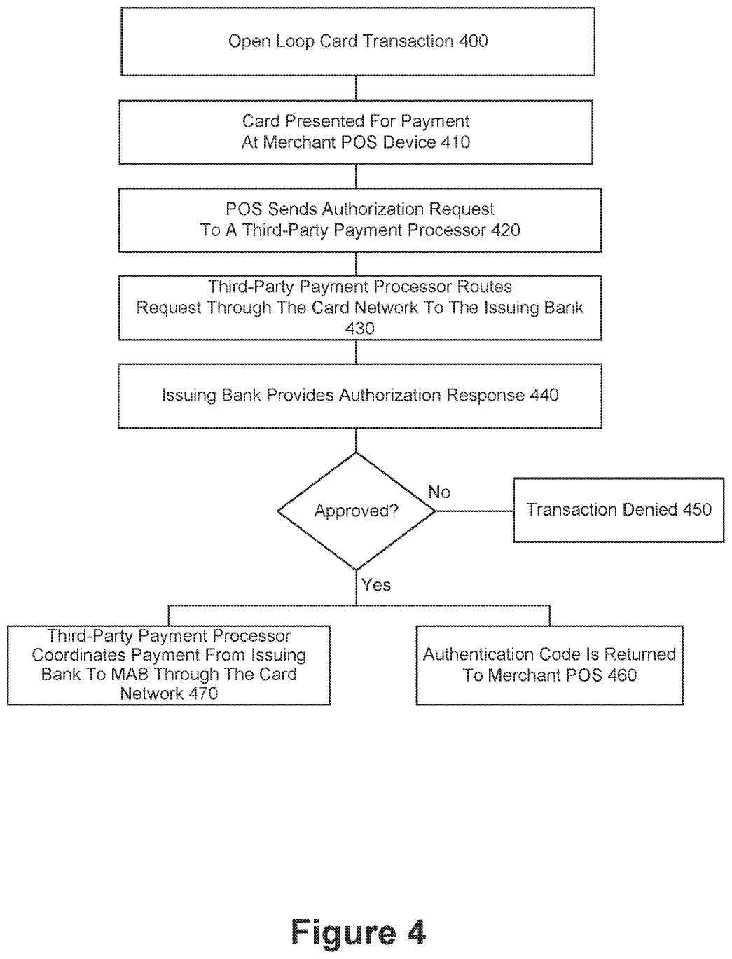

FIG. 4 illustrates an exemplary historical method for open-loop credit card authentication. At step 400 the process begins. At step 410, a credit card may be presented for payment at a point-of-sale device (e.g., a merchant transaction processing machine). Open-loop credit cards are generally not restricted to a single use location, but rather are accepted wherever the third-party processor maintains relationships with merchants. In step 410, a user may offer his or her credit card as a means for payment for whatever goods or services comprise the subject of the pending transaction. Presenting a credit card to a merchant POS device may comprise swiping the card through a magnetic strip reader on the POS device. In the event of chip cards, the card may be inserted into the POS device where a communication interface between the POS device and the chip on the card may be established. In other embodiments, there may be contactless presentation of the card to the POS device. This may occur through near field communication (e.g., a tap gesture with the credit card), RFID, use of a cell-phone proxy, etc. Presenting a credit card for payment at a merchant POS device may initiate a transaction request at the POS device. The transaction request may include specific information relevant to the requested transaction, such as the card holder's name, card number, expiration date, transaction amount, etc.

At step 420, the POS device may send an authorization request to a third-party payment processor. The authorization request may be based on the transaction request and include the information comprising the transaction request. This step may include establishing a network connection with the third-party payment processor. The POS device may transmit the authorization request to the third-party payment processor for routing through the card network. For instance, if the credit card is a Visa-based card, then, at step 420, the POS device would transmit the authorization request to Visa for routing through the Visa card network. Visa in turn, at step 430, may route the authorization request through the Visa card network to the issuing bank. For example, if the Visa-based credit card is from bank XYZ, then XYZ is the issuing bank for a Visa credit card, and the authorization request is routed through the Visa card network to XYZ. At step 440, XYZ may receive the authorization request and reference account records for the user in order to make an authorization determination. For instance, if the user is John Smith and the transaction request is for $100, then XYZ bank may look for active accounts for John Smith. Alternatively, XYZ may use the card number transmitted with the authorization request to see if there is a valid account associated with the card number. If there is an account, XYZ may reference account ownership, account standing, balance, available credit, etc. XYZ bank may compare the requested transaction amount and compare against the available credit limit for the account. For example, if the account has a $5,000 limit and a balance of $4,950, then a $100 transaction would put the account balance at $5,050 which is $50 over the account credit limit. In this scenario, at step 440, the transaction authorization request would be rejected. The authorization request may be rejected on grounds other than exceeding a credit limit. For example, if the card is expired, if the account is not in good standing, if there are indicia of fraud the authorization request may be rejected. There may be other bases for rejecting an authorization request. If the user's account meets all the relevant criteria for the attempted transaction, then the issuing bank (XYZ in the prior example), may approve the transaction.

If the issuing bank rejects the authorization request, then at step 450, the transaction is denied. This step may include the issuing bank sending the authorization response to the third-party payment processor through the card network. The third-party payment processor may, in turn, send the rejection to the merchant POS device. At this point, the merchant and the user may both see the credit card has been denied as a form of payment for the pending transaction.

If the issuing bank allows the authorization request, then at step 460, the transaction is approved. This step may include the issuing bank sending the authorization response, including an authentication code relating to the particulars of the approved transaction, to the third-party payment processor through the card network. The third-party payment processor may, in turn, send the approval to the merchant POS device. At this point, the merchant and the user may both see the credit card has been approved as a form of payment for the pending transaction. The transaction may be finalized with the POS device recording the authentication code against the transaction.

At step 470, the third-party payment processor may coordinate settlement of the approved transaction from the issuing bank to the merchant acquiring bank. This may include the third-party payment processor facilitating a funds transfer for the transaction amount from the issuing bank to the merchant acquiring bank. This may happen on a per-transaction basis and may incur a transaction fee payable by the merchant. In order to minimize the transaction fees, some merchants may operate their POS devices in a batch processing mode. In a batch processing mode, the POS device may store all the authentication codes for a period of time. This period of time may be determined and set by the merchant. The timing may be on a per-day basis, or more or less frequent depending on business needs. At the end of the batching period, the POS device may transmit all authentication codes to the third-party payment processor for batch settlement. In this instance, the third-party payment processor may only charge a single transaction fee to the merchant for all of the batched authentication codes. Alternatively, the third-party payment processor may only charge a single transaction fee for each issuing bank or some other quantifiable metric.

In some embodiments, a PLCC may be issued that is not directly connected to a merchant acquiring bank. In these instances, the PLCC may require processing through an open-loop authorization configuration, even if the issuing bank is the same as the merchant acquiring bank. Thus, in these instances, the process is that same as described with respect to FIG. 4, but that the settlement does not occur through the card network because the issuing bank and merchant acquiring bank are the same and no funds transfer is required.

In some embodiments, through circumstances or affirmative merchant decisions, a merchant POS might operate in open-loop without a network connection. This may happen if there is an internet disruption at a merchant, if vendors are operating remotely or while mobile, or any other situation where an internet connection may not be available. The options when there is no internet connection is to disrupt sales, or to operate the POS device offline in what is known as “store and forward” mode.

In a store and forward mode of operation, the transaction process appears to be the same to the consumer and the sales representative for the merchant. However, the POS device is not performing step 420 where the POS device sends an authorization request to a third-party payment processor. Therefore, the third-party payment processor cannot route the request to the issuing bank through the card network at step 430 and the issuing bank cannot provide an authorization response at step 440. Instead, the POS device fakes the authorization process and approves the transaction. In some embodiments it is possible for the POS device to determine obvious issues with a card presented for payment, such as an expired card. When the POS device approves the transaction without actually obtaining authorization from the issuing bank, it stores that transaction request. Then, at a later time, when there is an internet connection, it forwards the transaction requests to the third-party payment processor for routing to the issuing bank(s) for authorization. If a customer has paid with a bad credit card, then the issuing bank will refuse the transaction request like in step 450, but the actual transaction was already completed at the merchant and the consumer has likely left the merchant. Store and forward mode of POS device operation is best suited for instances where the goods or services are not immediately rendered to the consumer so that if the authorization request is ultimately denied, the merchant is protected. However, in instances where the goods or services are rendered at the point of sale, then the merchant may be out of luck if the transaction is subsequently refused by the issuing bank. For example, if a consumer orders a coffee at Starbucks and the pays with a bad credit card, under normal circumstances, the transaction request would be rejected by the issuing bank. However, if the Starbucks POS device is operating in store and forward mode, then the transaction will be approved. The consumer will receive the coffee and leave the Starbucks. At some later time, the POS device will forward the transaction request through the card network to the issuing bank and receive a refusal. However, the consumer has the coffee and has left the premise. In that scenario, Starbucks has lost the value of the transaction.

This same sort of problem may manifest in situations where an open-loop PLCC is offered for payment at a third-party merchant with a POS device operating in store and forward mode. If a traditional closed-loop PLCC card for Merchant A is presented at Merchant B, then the card will be rejected even if the POS device at Merchant B is operating in store and forward mode. This is because the card number associated with the closed-loop PLCC does not match a valid number for a recognized card network such as Visa or Mastercard. This is because, as noted above, closed-loop PLCC directly connect with the merchant operating bank and have their own management systems. However, if a PLCC relies on open-loop authentication, then a POS device at Merchant B may be fooled into authorizing a transaction for a PLCC associated with Merchant A.

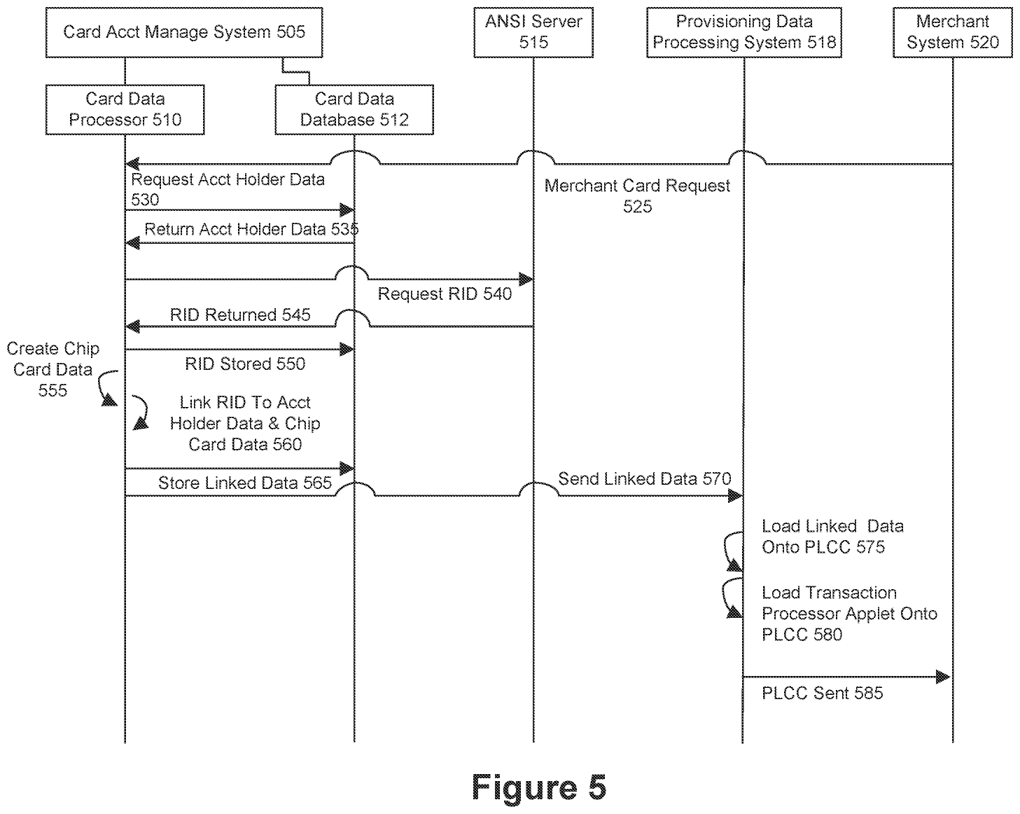

The sequence diagram of FIG. 5 illustrates an exemplary application of embodiments of the invention in conjunction with the system of FIG. 1 for provisioning an open-loop PLCC card with store and forward security. In the scenario set forth in FIG. 5, there is card account management system 505 from an issuing bank that may consists of a card data processor 510 and a card data database 512. The card account management system 505 is in communication with ANSI server 515, provisioning data processing system 518 and merchant system 520.

The sequence begins at step 525 where a request for a PLCC is sent from merchant system 520 to the card data processor 510 of the card account management system 505. In one embodiment, a consumer may visit the merchant and request a PLCC from the merchant. As a result, information for the consumer may be entered into merchant system 520. Once requisite information has been collected and entered, the merchant system 520 may generate the merchant card request for the consumer that is sent to the issuing bank's card account management system 505 at step 525.

In response to receiving a merchant card request, card data processor 510 may request account holder data from card data database 512 at step 530. This may entail looking up any data relating to the consumer such as an existing account, prior closed accounts, credit history, payment history, etc. At step 535, card data database 512 may return data for the consumer that is the subject of the merchant card request. The card data processor 510 may then create an account for the consumer based on the consumer data collected by the merchant system 520. This consumer data may be informed by any existing consumer data returned by the card data database 512 at step 535. In traditional PLCC processes, at this point, the account data would be loaded onto the chip of the PLCC, e.g., a Europay, Mastercard, or Visa (EMV) chip. However, in the sequence of FIG. 5, at step 540, the card data processor 510 may request a registered identifier (RID) number from the ANSI server 515 for the merchant of merchant system 520. In response to the RID number request, at step 545, the ANSI server 515 returns a RID number for the merchant of merchant system 520. For example, in one embodiment the merchant card request may originate from store ABC and be related to Joe Smith. Once the PLCC account has been set up for Joe Smith at the issuing bank's card data processor 510, the card data processor 510 will request a number that uniquely identifies ABC as the merchant for the PLCC. ANSI may be in charge of the unique identifying numbers.

Once the RID has been returned from the ANSI server 515 at step 545, the card data processor 510 may store that RID in card data database 512 at step 550. At step 555, card data processor 510 may create chip data for a physical PLCC. The chip data may include a card number, a pin number, a card verification value code, issue date, and an expiration date. The chip data may also include information about the issuing bank, the third-party processor/card network, and encryption software. At step 560, the RID number from the ANSI server 515 may be associated with the chip data that was created at step 555. At step 565 the linked chip data and RID may be stored together in the card data database 512.

In step 570, the linked chip data and RID may be sent to provisioning data processing system 518. The provisioning data processing system 518 may be in charge of programming chips. In some embodiments, this system may also be in charge of the physical manufacture of PLCC including embossing, printing, finishing, etc.

Once the provisioning data processing system 518 has received the linked chip data and RID, at step 575, it may upload that linked data into an for the requested PLCC. At step 580, the provisioning data processing system 518 may upload a transaction processor applet onto the chip of the PLCC. This may finalize the data and functionality of the requested PLCC. Finally, at step 585, the PLCC may be provided to the merchant system 520 for dissemination to the requesting consumer.

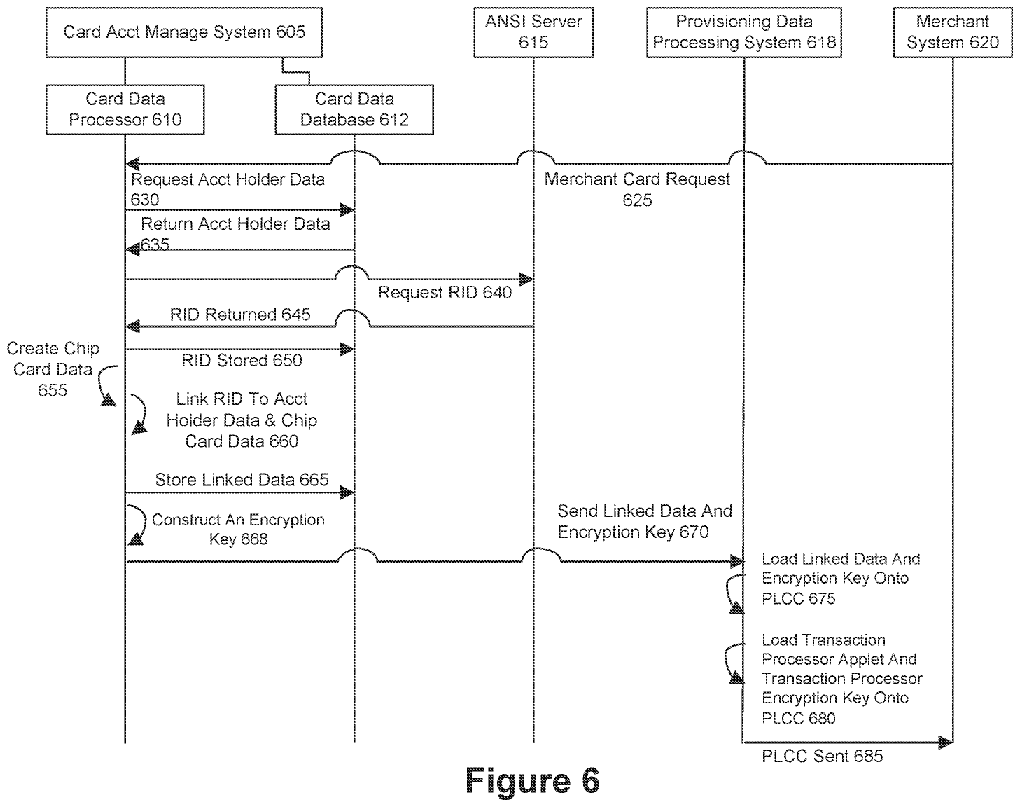

The sequence diagram of FIG. 6 illustrates an exemplary application of embodiments of the invention in conjunction with the system of FIG. 1 for provisioning an open-loop PLCC card with encrypted store and forward security. In the scenario set forth in FIG. 6, there is card account management system 605 from an issuing bank that may consists of a card data processor 510 and a card data database 612. The card account management system 605 is in communication with ANSI server 615, provisioning data processing system 618 and merchant system 620.

The sequence begins at step 625 where a request for a PLCC is sent from merchant system 620 to the card data processor 610 of the card account management system 605. In one embodiment, a consumer may visit the merchant and request a PLCC from the merchant. As a result, information for the consumer may be entered into merchant system 620. Once requisite information has been collected and entered, the merchant system 620 may generate the merchant card request for the consumer that is sent to the issuing bank's card account management system 605 at step 625.

In response to receiving a merchant card request, card data processor 610 may request account holder data from card data database 612 at step 630. This may entail looking up any data relating to the consumer such as an existing account, prior closed accounts, credit history, payment history, etc. At step 635, card data database 612 may return data for the consumer that is the subject of the merchant card request. The card data processor 610 may then create an account for the consumer based on the consumer data collected by the merchant system 620. This consumer data may be informed by any existing consumer data returned by the card data database 612 at step 635. In traditional PLCC processes, at this point, the account data would be loaded onto the chip of the PLCC. However, in the sequence of FIG. 6, at step 640, the card data processor 610 may request a registered identifier (RID) number from the ANSI server 615 for the merchant of merchant system 620. In response to the RID number request, at step 645, the ANSI server 615 returns a RID number for the merchant of merchant system 620. For example, in one embodiment the merchant card request may originate from store ABC and be related to Joe Smith. Once the PLCC account has been set up for Joe Smith at the issuing bank's card data processor 610, the card data processor 610 will request a number that uniquely identifies ABC as the merchant for the PLCC. ANSI may be in charge of the unique identifying numbers.

Once the RID has been returned from the ANSI server 615 at step 645, the card data processor 610 may store that RID in card data database 612 at step 650. At step 655, card data processor 610 may create chip data for a physical PLCC. The chip data may include a card number, a pin number, a card verification value code, issue date, and an expiration date. The chip data may also include information about the issuing bank, the third-party processor/card network, and encryption software. At step 660, the RID number from the ANSI server 615 may be associated with the chip data that was created at step 655. At step 665 the linked chip data and RID may be stored together in the card data database 612. The stored data may comprise a stored record in database 612.

At step 668, the card data processor 610 may construct a card manager encryption key. The card manager encryption key may be created using at least the RID and in some embodiments, the chip data. The card manager encryption key may be part of the security for open-loop PLCCs used at third-party merchants with POS devices operating in store and forward mode. In some embodiments, the chip data may be encrypted based on the card manager encryption key. In some embodiments the RID may be encrypted based on the card manager encryption key. In some embodiments some portion of the chip data and RID may be encrypted based on the card manager encryption key.

In step 670, the linked chip data and RID may be sent, along with the card manager encryption key to provisioning data processing system 618. The provisioning data processing system 618 may be in charge of programming chips. In some embodiments, this system may also be in charge of the physical manufacture of PLCC including embossing, printing, finishing, etc.

Once the provisioning data processing system 618 has received the linked chip data and RID, and the card manager encryption key, at step 675, it may upload that linked data and card manager encryption key into a chip for the requested PLCC. As a result of uploading the RID and card manager encryption key, the chip for the requested PLCC may be configured for communication with a merchant transaction card processing device. Similarly, the chip card data and the RID may be configured for use by the merchant transaction card processing device to do one or both of direct transaction processing information to a transaction processing system of the financial institution and determine at the PLCC-merchant transaction card processing device interface if the PLCC is associated with the merchant.

At step 680, the provisioning data processing system 518 may upload a transaction processor applet and a transaction processor encryption key onto the chip of the PLCC. This may finalize the data and functionality of the requested PLCC.

The card manager encryption key and transaction processor encryption key may be different encryption keys. The transaction processor encryption key may be part of an encryption framework for securing general transactions at a POS device and across a card network. The transaction processor encryption key technology is described more fully in other patent applications such as Ser. Nos. 17/890,628; 16/205,119; and 16/590,290. While the transaction processor encryption key ensures security of the underlying credit card transaction, the card manager encryption key maintains the security of merchant based data, including the RID, in the scenario where a PLCC merchant must be verified offline between the PLCC and the POS device.

Finally, at step 685, the PLCC may be provided to the merchant system 620 for dissemination to the requesting consumer.

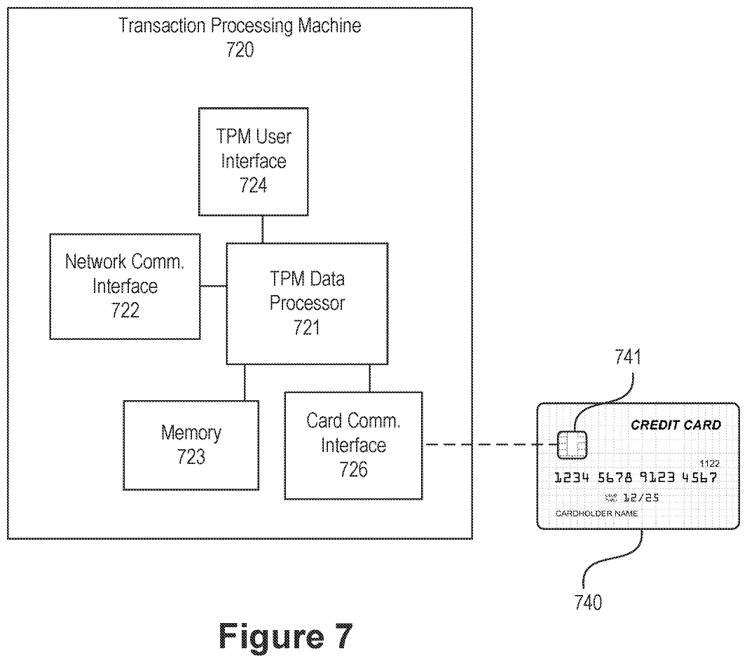

With reference to FIG. 7, the transaction processing machine (TPM) 720 may be any network enabled processor configured for processing a transaction involving a transaction card 740. The TPM 720 may be, for example, a cash register, automated teller machine, vending machine, or other POS terminal that is capable of communicating with the transaction card 740 and is capable of communicating with a card network via the network 130. In some embodiments, the TPM 720 may include a TPM data processor 721, a network communication interface 722, a TPM user interface 724, a memory 723, and a card communication interface 726.

The TPM data processor 721 can include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The memory 723 can be a read-only memory, write-once read-multiple memory or read/write memory, e.g., RAM, ROM and EEPROM, and the transaction processing machine 720 can include one or more of these memories.

The TPM user interface 724 may include a user input mechanism, which can be any device for entering information and instructions into the TPM 720, such as a touch-screen, keyboard, mouse, cursor-control device, microphone, stylus, or digital camera. The user interface 724 may also include a display, which can be any type of device for presenting visual information such as a computer monitor, a flat panel display, and a mobile device screen, including liquid crystal displays, light-emitting diode displays, plasma panels, and cathode ray tube displays.

The network communication interface 722 may be configured to establish and support wired or wireless data communication capability for connecting the TPM 720 to the network 130 or other communication network. The card communication interface 726 may be configured for receiving the transaction card 740 and making electrical contact for wired communication between the TPM data processor 721 and the data processing chip 741. Alternatively or in addition, the card communication interface 726 may be configured to support short-range wireless communications between the transaction card 740 and the TPM data processor such as near field communication (NFC), radio-frequency identification, and Bluetooth. The card communication interface 726 may, in particular, be configured for establishing wired or wireless communication with the data processing chip 741 on board the transaction card 740 and for receiving information transmitted by the data processing chip 741 via the card communication interface 726.

In embodiments of the invention, the TPM memory 723 may have stored therein one or more applications usable by the data processor 721 to conduct transactions and to communicate with a transaction processing system. These applications may include instructions usable by the data processor 721 to identify transaction events, store event data in the memory 723, and communicate event data. In some embodiments, they may include instructions for receiving and transmitting transaction messages from the transaction card 740. The application may be configured to instruct the data processor 721 to interpret some or all of the unencrypted portion of a message.

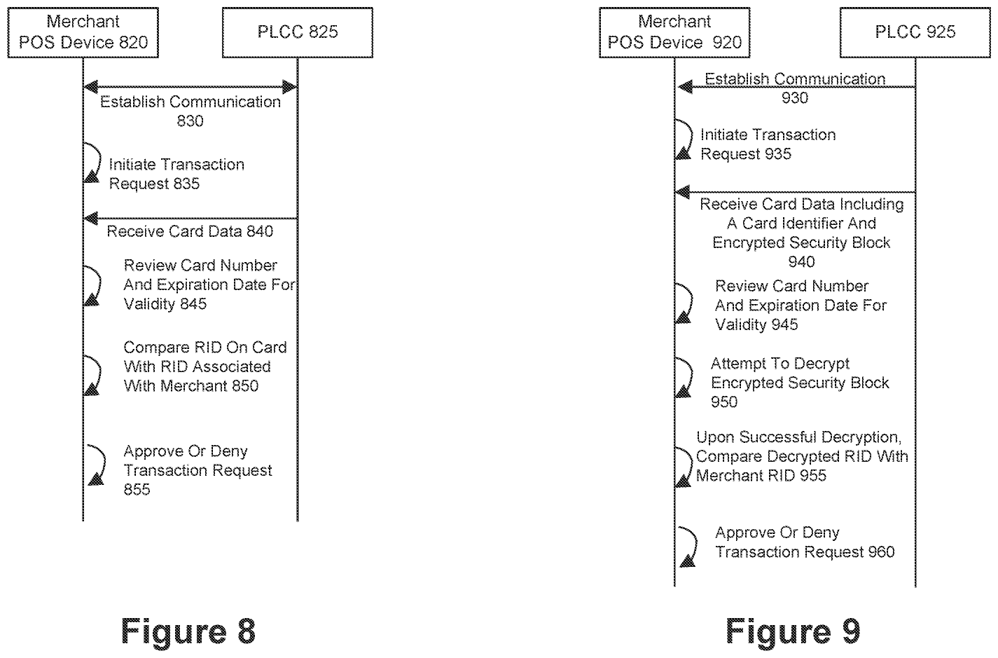

The sequence diagram of FIG. 8 illustrates an exemplary application of embodiments of the invention in conjunction with the system of FIG. 2 for securely processing an open-loop PLCC at a third-party merchant with a transaction processing machine operating in store and forward mode. In the scenario set forth in FIG. 8, there is a merchant POS device 820 in communication with PLCC 825.

The sequence begins at step 830 where a request connection is made between merchant POS device 820 and PLCC 825. This connection may comprise a communication connection and may be a result of a NFC, card swipe, card insertion, or any other way in which a credit card may be offered for payment to a POS device. The establishment of a communication between merchant POS device 820 and PLCC 825 may be the result of a consumer offering a PLCC as payment for goods or services at a merchant.

At step 835, in response to the PLCC being offered as payment and the establishment of communication at step 830, the merchant POS device 820 may initiate a transaction request. The transaction request may be initiated entirely offline and without a network connection to a third-party processor or a card network. For example, the merchant POS device 820 may be operating in store and forward mode. In this mode of operation, merchant POS device 820 will initiate a transaction request and then process that transaction request internal to the merchant POS device 820. The merchant POS device 820 will not send the request to a third-party processor, and therefore, the transaction request will not be reviewed or considered by the issuing bank. The issuing bank will not have the opportunity to approve or deny the transaction request. Instead, the merchant POS device 820 will perform a cursory authorization process that will mimic the normal network-based transaction process without actual knowledge of the account standing or criteria that might cause an issuing bank to refuse the transaction. In the absence of this information, merchant POS device 820 may approve transactions that would otherwise be refused by the issuing bank.

The transaction request of step 835 may be based on the particulars of the pending sale, such as sale items and pricing. In support of the transaction request at step 835, the merchant POS device may receive card data at step 840 that may be necessary to process the transaction request. The card data may include a card number and expiration date. In some embodiments, the card data may also include one or more of a CVV, an issuing bank, a cardholder name, etc. The card data includes a RID that may be tied or linked to the card data. The RID may not be relevant to any specific aspect of the consumer's account, other than the RID may uniquely identify the merchant associated with the PLCC. For example, if the consumer has obtained a store ABC branded PLCC, then the card data on a chip or magnetic stripe for PLCC 825 would include a RID tied exclusively to ABC.

At step 845, the merchant POS device 820, operating in store and forward mode, may attempt to verify the PLCC 825. This may entail reviewing the expiration date against a current date stored in the merchant POS device 820. The review at step 845 may also include a verification that the card number is a valid number for an open-loop card network such at Visa® or Mastercard®. If the card is expired then the merchant POS device 820 may refuse the transaction request. Also, if the merchant POS device 820 detects that the card number is not a valid and recognized number for a partner card network, then the merchant POS device 820 may refuse the transaction request. For example, if a closed-loop PLCC is offered for payment at a merchant POS device operating in store and forward mode, then the merchant POS device will not be able to recognize the card number because it will not be a number that is valid for an open-loop card network. In this case, the merchant POS 820 device would refuse the transaction request. However, in the scenario where an open-loop PLCC is offered for payment, then the merchant POS device operating in store and forward mode would be able to verify the validity of the card number vis-à-vis an open-loop card network. Accordingly, the merchant POS device 820 would not refuse an open-loop PLCC on this basis.

At step 850, the merchant POS 820 may compare the RID from the card data of open-loop PLCC 825 with a RID for the merchant POS device 820. For example, the merchant POS device 820 may have stored within memory, a RID associated with the merchant where the merchant POS device 820 resides. From the prior example, if the consumer offers a ABC branded PLCC for payment, then the RID from the card data will be a number that uniquely identifies ABC If the merchant POS device is located at an ABC store, then the RID stored within the POS device's memory will match the RID from the card data of the ABC branded PLCC. Alternatively, if the merchant POS device is located at some other store, then the RID stored within the POS device's memory will not match the RID from the card data of the ABC branded PLCC. In some embodiments, the POS device RID may be downloaded from the merchant acquiring bank when it is connected to a network. In another embodiment, there may be a RID master list maintained by ANSI or some other entity. The RID master list may be pushed to POS devices over a network connection and may be updated from time to time. In this scenario, if an ABC branded PLCC is used at a store other that ABC, the POS device would not only detect a mismatch between the store RID for the POS device and the card data RID, but the POS device would be able to reference the list and determine what type of PLCC was offered for the pending transaction. In this scenario, the POS device could provide feedback to the consumer over a display alerting them of the PLCC mismatch.

At step 855, the transaction attempt may be approved or denied. This approval or denial may be based at least in part on the RID comparison in step 850. As explained, if the merchant RID stored in the merchant POS device 820 matches the RID from the card data of PLCC 825, then the transaction will be approved. If there is a RID mismatch, then the transaction will be denied. Approval may include allowing the POS transaction to continue processing through the transaction processing device as an open-loop, offline store and forward POS transaction.

The sequence diagram of FIG. 9 illustrates an exemplary application of embodiments of the invention in conjunction with the system of FIG. 2 for securely processing an open-loop PLCC at a third-party merchant with a transaction processing machine operating in store and forward mode. In the scenario set forth in FIG. 9, there is a merchant POS device 920 in communication with PLCC 925.

The sequence begins at step 930 where a request connection is made between merchant POS device 920 and PLCC 925. This connection may comprise a communication connection and may be a result of a NFC, card swipe, card insertion, or any other way in which a credit card may be offered for payment to a POS device. The establishment of a communication between merchant POS device 920 and PLCC 925 may be the result of a consumer offering a PLCC as payment for goods or services at a merchant.

At step 935, in response to the PLCC being offered as payment and the establishment of communication at step 930, the merchant POS device 920 may initiate a transaction request. The transaction request may be initiated entirely offline and without a network connection to a third-party processor or a card network. For example, the merchant POS device 920 may be operating in store and forward mode. In this mode of operation, merchant POS device 920 will initiate a transaction request and then process that transaction request internal to the merchant POS device 920. The merchant POS device 920 will not send the request to a third-party processor, and therefore, the transaction request will not be reviewed or considered by the issuing bank. The issuing bank will not have the opportunity to approve or deny the transaction request. Instead, the merchant POS device 920 will perform a cursory authorization process that will mimic the normal network-based transaction process without actual knowledge of the account standing or criteria that might cause an issuing bank to refuse the transaction. In the absence of this information, merchant POS device 920 may approve transactions that would otherwise be refused by the issuing bank.

The transaction request of step 935 may be based on the particulars of the pending sale, such as sale items and pricing. In support of the transaction request at step 935, the merchant POS device may receive card data at step 940 that may be necessary to process the transaction request. The card data may include a card number and expiration date. In some embodiments, the card data may also include one or more of a CVV, an issuing bank, a cardholder name, etc. The card data includes a RID that may be tied or linked to the card data. The RID may not be relevant to any specific aspect of the consumer's account, other than the RID may uniquely identify the merchant associated with the PLCC. For example, if the consumer has obtained an ABC branded PLCC, then the card data on an chip or magnetic stripe for PLCC 925 would include a RID tied exclusively to ABC. The card data may also include an encrypted security block. In one embodiment, the encrypted security block may include the RID, so the RID may be encrypted. In another embodiment, the encrypted security block may include card data required to complete the transaction.

At step 945, the merchant POS device 920, operating in store and forward mode, may attempt to verify the PLCC 925. This may entail reviewing the expiration date against a current date stored in the merchant POS device 920. The review at step 945 may also include a verification that the card number is a valid number for an open-loop card network such at Visa® or Mastercard®. If the card is expired then the merchant POS device 920 may refuse the transaction request. Also, if the merchant POS device 920 detects that the card number is not a valid and recognized number for a partner card network, then the merchant POS device 920 may refuse the transaction request. For example, if a closed-loop PLCC is offered for payment at a merchant POS device operating in store and forward mode, then the merchant POS device will not be able to recognize the card number because it will not be a number that is valid for an open-loop card network. In this case, the merchant POS 920 device would refuse the transaction request. However, in the scenario where an open-loop PLCC is offered for payment, then the merchant POS device operating in store and forward mode would be able to verify the validity of the card number vis-à-vis an open-loop card network. Accordingly, the merchant POS device 920 would not refuse an open-loop PLCC on this basis.

As noted with respect to step 940, in some embodiments the encrypted security block may include the PLCC card data. In these embodiments it may not be possible to review the card number and expiration date for the PLCC 925 before decrypting the encrypted security block. In this scenario, step 945 may occur after step 950.

At step 950, the merchant POS device may attempt to decrypt the encrypted security block. The attempted decryption may be based on a security key within the merchant POS device 920. The security key may be universal. In another embodiment, the security key may be tied to the specific card network. For example, there may be a different security key for Visa®, Mastercard®, etc. The merchant POS device 920 may apply the universal security key to decrypt the security block. Alternatively, if there is a per-card network set of security keys, the merchant POS device 920 may each key until one correctly decrypts the encrypted security block. In yet another embodiment, the security key is based on an RID for the merchant associated with the merchant POS device 920. In this embodiment, the encrypted security block may be based on the RID that is part of the PLCC 925 and which uniquely identifies the merchant that issued the PLCC 925. Only if the security key in the merchant POS device 920 is based on the same RID as the encrypted security block of the PLCC 925 will decryption of the security block be possible. Thus, if the security key is able to decrypt the encrypted security block, then there may be an assumption that the RID from the card data of the PLCC 925 should match the RID stored on the merchant POS device 920.

At step 955, the merchant POS 920 may compare the RID from the card data of open-loop PLCC 925 with a RID for the merchant POS device 920. For example, the merchant POS device 920 may have stored within memory, a RID associated with the merchant where the merchant POS device 920 resides. From the prior example, if the consumer offers an ABC branded PLCC for payment, then the RID from the card data will be a number that uniquely identifies ABC. If the merchant POS device is located at a ABC store, then the RID stored within the POS device's memory will match the RID from the card data of the ABC branded PLCC. Alternatively, if the merchant POS device is located at some other store, then the RID stored within the POS device's memory will not match the RID from the card data of the ABC branded PLCC. In some embodiments, the POS device RID may be downloaded from the merchant acquiring bank when it is connected to a network. In another embodiment, there may be a RID master list maintained by ANSI or some other entity. The RID master list may be pushed to POS devices over a network connection and may be updated from time to time. In this scenario, if an ABC branded PLCC is used at a store other that ABC, the POS device would not only detect a mismatch between the store RID for the POS device and the card data RID, but the POS device would be able to reference the list and determine what type of PLCC was offered for the pending transaction. In this scenario, the POS device could provide feedback to the consumer over a display alerting them of the PLCC mismatch.

At step 960, the transaction attempt may be approved or denied. This approval or denial may be based at least in part on the RID comparison in step 955 and/or the decryption of the encrypted security block at step 950. As explained, if the merchant RID stored in the merchant POS device 920 matches the RID from the card data of PLCC 925, then the transaction will be approved. If there is a RID mismatch, then the transaction will be denied. In some embodiments, the merchant POS device 920 may encrypt some portion of the transaction request using encryption based on the merchant RID before forwarding the transaction request to the third party processor for routing through the card network. This may achieve a higher level of security for PLCCs operating on open-loop networks. In this scenario, the issuing bank which is also the merchant acquiring bank, would know the merchant RID and have access to the security key or keys required to decrypt the transaction request. In some embodiments, approval may include allowing the POS transaction to continue processing through the transaction processing device as an open-loop, offline store and forward POS transaction, and in some embodiments, this only occurs upon successful decryption of the encrypted security block.

It is noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

We claim:

1. A method of provisioning a merchant transaction card having a card data processor and a card memory, the method comprising:
obtaining, by a card account management system associated with a financial institution, a registered identifier (RID) uniquely associated with the financial institution and a merchant;
associating, by the card account management system, chip card information with a card account associated with an account holder, the chip card information including a unique chip card identifier;
constructing at least one card manager encryption key using the RID and card-unique chip card information;
transmitting, by the card account management system to a provisioning data processing system, the chip card information, the RID, the at least one card manager encryption key, and account holder information associated with the account holder;
loading, by the provisioning data processing system into the card memory, the chip card information, the RID, and the at least one card manager encryption key; and
loading, by the provisioning data processing system into the card memory, a transaction processor applet and at least one transaction processor encryption key associated with a transaction processing entity.

2. A method according to claim 1 further comprising:
encrypting at least a portion of the chip card information by the card account management system prior to the action of transmitting.

3. A method according to claim 2 wherein the at least a portion of the chip card information is encrypted using the at least one card manager encryption key.

4. A method according to claim 1 further comprising:
encrypting the RID by the card account management system prior to the action of transmitting.

5. A method according to claim 4 wherein the at RID is encrypted using the at least one card manager encryption key.

6. A method according to claim 1 further comprising:
storing, by the card account management system in a card account database, a card account record including a card account identifier, the account holder information, and at least a portion of the chip card information.

7. A method according to claim 1 wherein the merchant transaction card is configured for communication with a merchant transaction card processing device and the chip card information and the RID are configured for use by the merchant transaction card processing device to direct transaction processing information to a transaction processing system of the financial institution.

8. A method for processing a merchant account card transaction request, the method comprising:
establishing communication, by a transaction processing device operating in an offline store and forward transaction mode, with a card data processor of a transaction card presented to a merchant for use in completing a point-of-sale (POS) transaction;
receiving card information by the transaction processing device from the card data processor, the card information including a card identifier and a card registered unique identifier (RID);
determining, by the transaction processing device, whether the card RID matches a merchant RID stored in a memory of the transaction processing device and associated with the merchant and a financial institution;
responsive to a determination that the card RID does not match the merchant RID, refusing the POS transaction by the transaction processing device; and
responsive to a determination that the card RID matches the merchant RID, allowing the POS transaction to continue processing through the transaction processing device as an open-loop, offline store and forward POS transaction.

9. A method according to claim 8 wherein the method further comprises, responsive to a determination that the card RID matches the merchant RID:
determining, by the transaction processing device, whether the card information includes an encrypted security block; and
responsive to determining that the card information includes an encrypted security block, attempting to decrypt the encrypted security block using a merchant-unique security key,
wherein the action of allowing the POS transaction to continue processing through the transaction processing device as an open-loop, offline store and forward POS transaction is carried out only upon successful decryption of the encrypted security block.

10. A method according to claim 9 further comprising, responsive to a determination that the card information does not include an encrypted security block:
denying the POS transaction by the transaction processing device.

11. A method according to claim 9 further comprising, responsive to a failure to decrypt the encrypted security block:
denying the POS transaction by the transaction processing device.

12. A method according to claim 9 wherein the merchant-unique security key is generated using the merchant RID.

13. A method according to claim 9 wherein the encrypted security block includes encrypted account holder information.

14. A method according to claim 9 further comprising, responsive to a determination that the card RID matches the merchant RID:
prior to forwarding a stored transaction through an open-loop card network, encrypting at least a portion of the transaction information using the merchant-unique security key, the encrypted portion of the transaction information being included in the merchant card transaction request.

15. A point-of-sale (POS) transaction processing device operating in an offline store and forward transaction mode comprising:
a transaction card communication interface configured to establish communication with a card data processor of a transaction card presented for use in completing a POS transaction at a POS location associated with a merchant;
a network communication interface configured for selective communication over a network;
a data processor; and
a transaction processor memory having stored therein a transaction processing application comprising instructions for the data processor to:
receive card information from the card data processor via the transaction card communication interface, the card information including a card identifier and a card registered unique identifier (RID),
determine whether the card RID matches a merchant RID associated with the merchant and a financial institution, and
responsive to a determination that the card RID matches the merchant RID, allowing the POS transaction to continue processing through the transaction processing device as an open-loop, offline store and forward POS transaction.

16. A POS transaction processing device according to claim 15 wherein the transaction processing application further comprises instructions for the data processor to:
responsive to a determination that the card RID does not match the merchant RID, and refuse the POS transaction by the transaction processing device.

17. A POS transaction processing device according to claim 15 wherein the transaction processor memory also has stored therein a merchant-unique security key associated with the merchant and the financial institution and the transaction processing application further comprises instructions for the data processor to, responsive to a determination that the card RID matches the merchant RID,
determine whether the card information includes an encrypted security block,
responsive to determining that the card information includes an encrypted security block, attempt to decrypt the encrypted security block using the merchant-unique security key, and
carry out the action allow the POS transaction to continue processing through the transaction processing device as an open-loop, offline store and forward POS transaction only upon successful decryption of the encrypted security block.

18. A POS transaction processing device according to claim 17 wherein the transaction processing application further comprises instructions for the data processor to, responsive to either a determination that the card information does not include an encrypted security block or a failure to decrypt the encrypted security block, deny the POS transaction by the transaction processing device.

19. A POS transaction processing device according to claim 18 wherein the encrypted security block includes encrypted account holder information.

20. A POS transaction processing device according to claim 17 wherein the transaction processing application further comprises instructions for the data processor to, responsive to a determination that the card RID matches the merchant RID:
prior to the action of forwarding a stored transaction through an open-loop card network, encrypt at least a portion of the transaction information using the merchant-unique security key.
